(19) United States
(12) Patent Application Publication
(10) Pub. No.: US 2021/0197332 A1
(43) Pub. Date: Jul. 1, 2021

(54) TRANSMISSION STRUCTURE OF WOODWORKING LATHE

(71) Applicant: MINCHUEN ELECTRICAL MACHINERY CO., LTD, TAICHUNG CITY (TW)

(72) Inventor: TA CHUANG WEI, TAICHUNG CITY (TW)

(21) Appl. No.: 17/060,279

(22) Filed: Oct. 1, 2020

(30) Foreign Application Priority Data
Dec. 31, 2019 (TW) M597694

(51) Int. Cl. B23Q 5/12

(52) U.S. Cl. CPC B23Q 5/12; B23Q 2705/064

(57) ABSTRACT

A transmission structure of a woodworking lathe contains: a case, a driven gear, a first gear set, a second gear set, and an adjustment lever. The case includes a transmission shaft, a variable speed shaft, and a driven shaft. The driven gear is fixed on the variable speed shaft and meshes with the transmission gear. The first gear set contains a first gear and a third gear which is coaxial with the first gear. Diameters of the first gear and the third gear are different. The second gear set is disposed on the variable speed shaft and contains a second gear and a fourth gear, a diameter of the second gear corresponds to a diameter of the first gear, and a diameter of the fourth gear corresponds to a diameter of the third gear. The adjustment lever is defined between the second gear and the fourth gear.

### FIELD OF THE INVENTION

The present invention relates to a transmission structure which is configured to drive a woodworking lathe by gears.

### BACKGROUND OF THE INVENTION

A conventional woodworking lathe contains a spindle actuated workpieces to rotate and to cut by a tool, wherein the workpieces are cut in different shapes and at different cutting forces, thus having different torques and rotating speeds provided by a transmission mechanism. The woodworking lathe further contains at least one cone pulley and a motor configured to send a torque to the at least one cone pulley via at least one belt so as to change a transmission ratio of a motor gear and to adjust a position of the at least one belt corresponding to the at least one cone pulley, thus obtaining different torques and rotating speed. However, when the position of the at least one belt is adjusted manually, for example, opening a cover of the transmission mechanism, removing a fixing device of the motor gear, adjusting the motor gear, adjustably moving the at least one belt to behind the at least one cone pulley so as to adjust a tension of the at least one belt and a position of the motor, thus mating at least one receiving slot with the at least one cone pulley and obtaining suitable tension of the at least one belt.

However, the conventional transmission structure has defeats as follows:

(1). When drilling workpieces of different materials by ways of a drilling machines, a rotating speed of the drilling machine is changed by opening the cover of the transmission mechanism, expanding the at least one belt, and fitting the belt to the at least one cone pulley of different sizes, thus having troublesome operation.

(2). A length of the at least one belt is fixed to limit a transmission ratio. In addition, the motor is started in a low rotating speed when adjusting the at least one cone pulley and the at least one belt, thus injuring a user's finger easily.

(3). A transmission efficiency of the at least one belt, the motor gear, and the at least one cone pulley is low, and a sliding occurs when the at least one belt, the motor gear, and the at least one cone pulley rotate. Furthermore, the at least one belt has to be replaced to cause high replacement and maintenance cost.

Accordingly, it is complicated, danger, and time-consuming to adjust the torque and the rotating speed of the woodworking lathe.

The present invention has arisen to mitigate and/or obviate the afore-described disadvantages.

### SUMMARY OF THE INVENTION

The primary objective of the present invention is to provide a transmission structure of a woodworking lathe which contains multiple gear sets, a transmission shaft, a variable speed shaft, and a driven shaft, wherein the multiple gear sets are defined between the variable speed shaft and the driven shaft so that the adjustment lever controls one of the multiple gears to move in different positions, such that different gears mesh or do not mesh, thus adjusting different speeds and obtaining idle rotation.

### BRIEF DESCRIPTION OF THE DRAWINGS

FIG. 1 is a side plan view showing the assembly of a woodworking lathe according to a first embodiment of the present invention.

FIG. 2 is a perspective view showing the exploded components of the transmission structure of the woodworking lathe according to the first embodiment of the present invention.

FIG. 3 is a cross sectional view showing the assembly of the transmission structure of the woodworking lathe according to the first embodiment of the present invention.

FIG. 4 is another cross sectional view showing the assembly of the transmission structure of the woodworking lathe according to the first embodiment of the present invention.

FIG. 5 is a cross sectional view showing the operation of the transmission structure of the woodworking lathe according to the first embodiment of the present invention.

FIG. 6 is another cross sectional view showing the operation of the transmission structure of the woodworking lathe according to the first embodiment of the present invention.

FIG. 7 is also another cross sectional view showing the operation of the transmission structure of the woodworking lathe according to the first embodiment of the present invention.

FIG. 8 is still another cross sectional view showing the operation of the transmission structure of the woodworking lathe according to the first embodiment of the present invention.

FIG. 9 is a cross sectional view showing the assembly of a speed change device of the transmission structure of the woodworking lathe according to the first embodiment of the present invention.

FIG. 10 is a cross sectional view showing the operation of the speed change device of the transmission structure of the woodworking lathe according to the first embodiment of the present invention.

FIG. 11 is a cross sectional view showing the assembly of a transmission structure of a woodworking lathe according to a second embodiment of the present invention.

FIG. 12 is a cross sectional view showing the assembly of the transmission structure of the woodworking lathe according to a third embodiment of the present invention.

FIG. 13 is a cross sectional view showing the operation of the transmission structure of the woodworking lathe according to the third embodiment of the present invention.

FIG. 14 is a cross sectional view showing the assembly of the transmission structure of the woodworking lathe according to a fourth embodiment of the present invention.

FIG. 15 is a cross sectional view showing the operation of the transmission structure of the woodworking lathe according to the fourth embodiment of the present invention.

FIG. 16 is a cross sectional view showing the operation of the transmission structure of the woodworking lathe according to the fourth embodiment of the present invention.

### DETAILED DESCRIPTION OF THE PREFERRED EMBODIMENTS

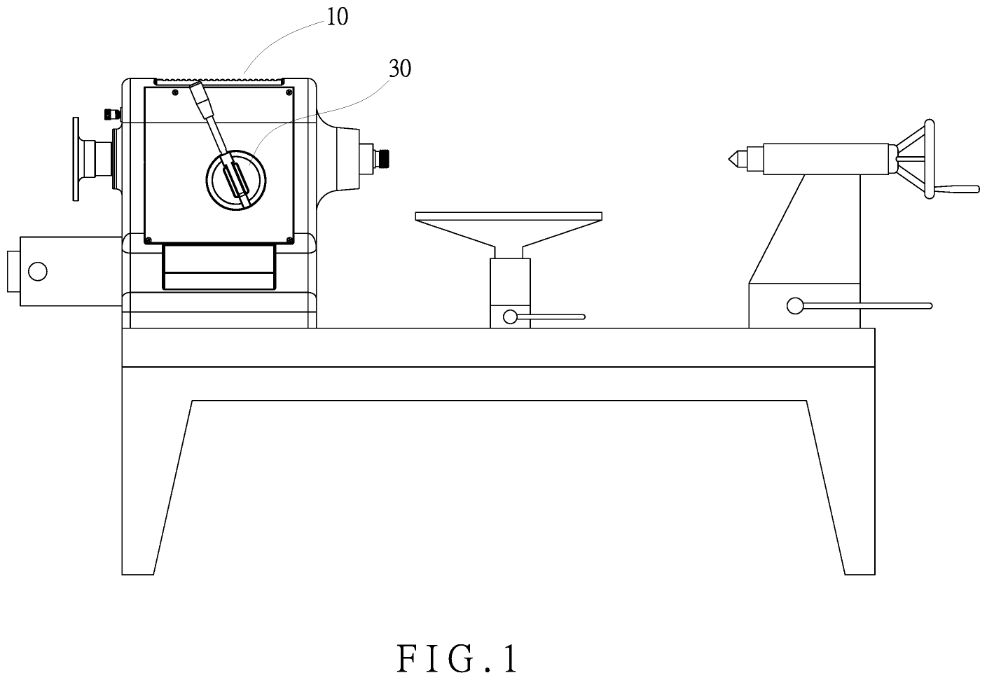

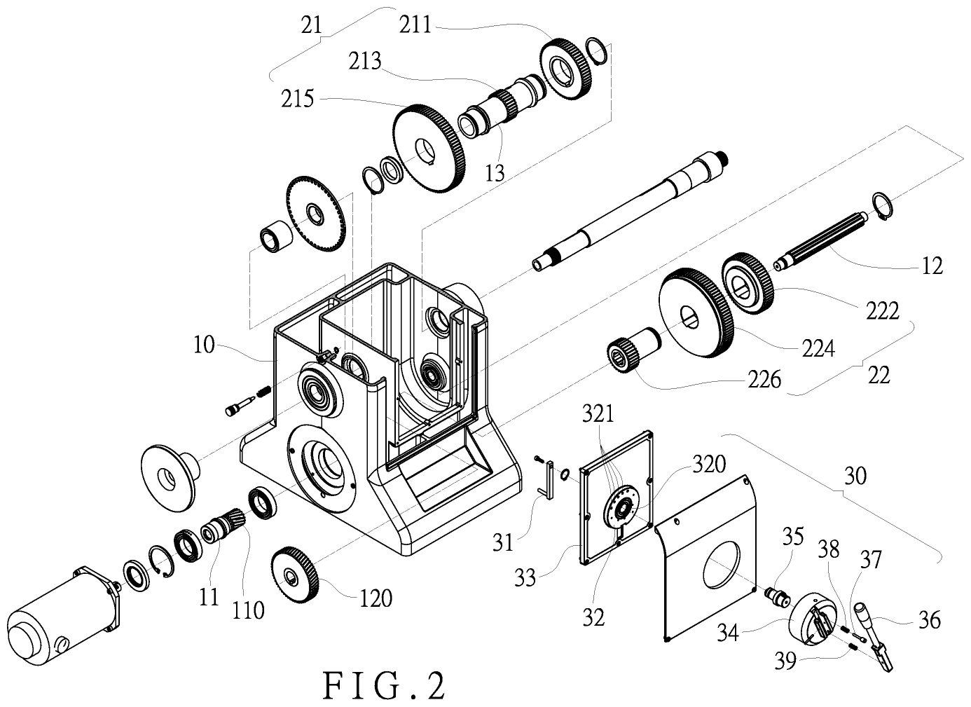

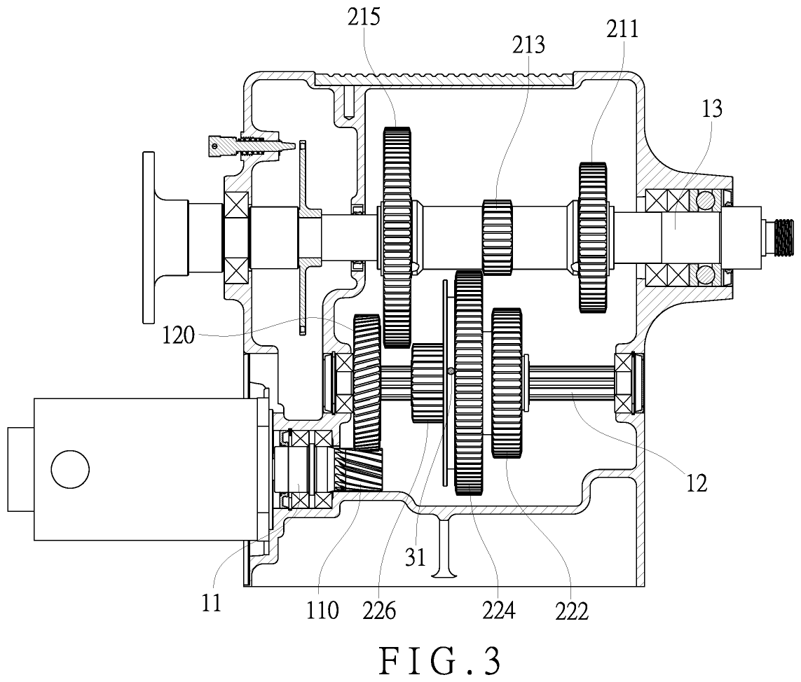

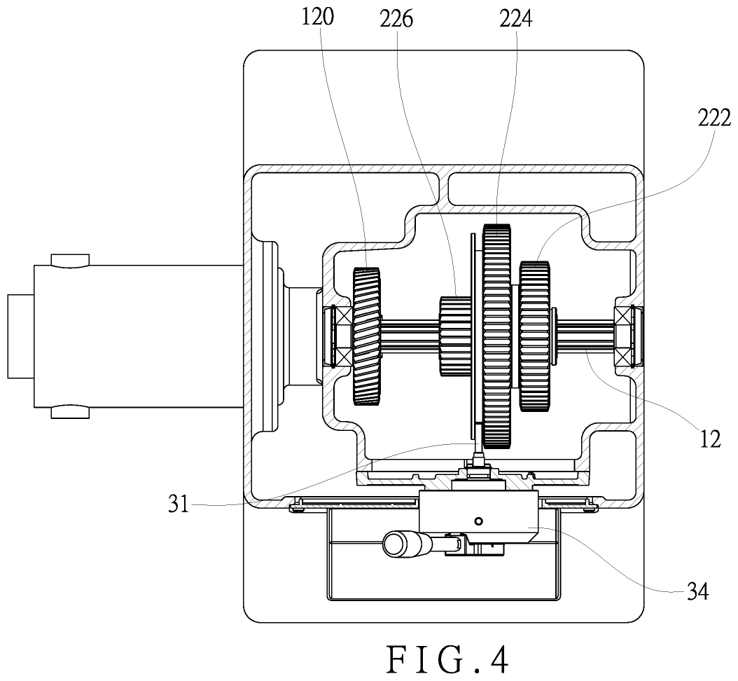

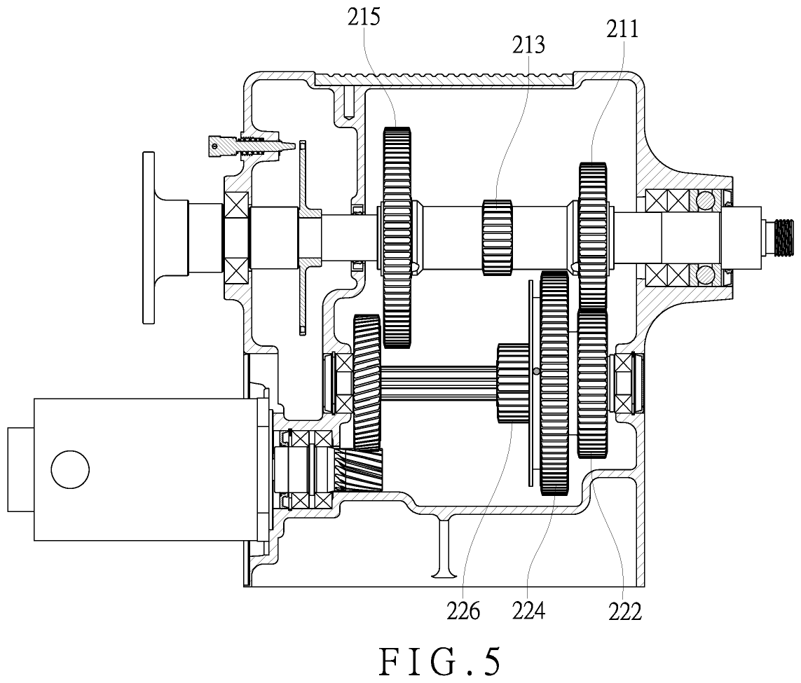

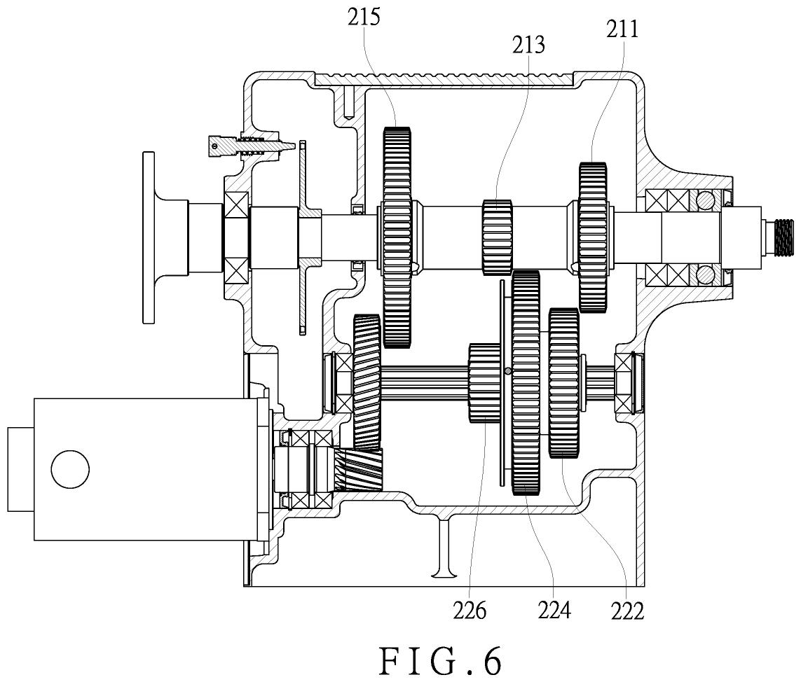

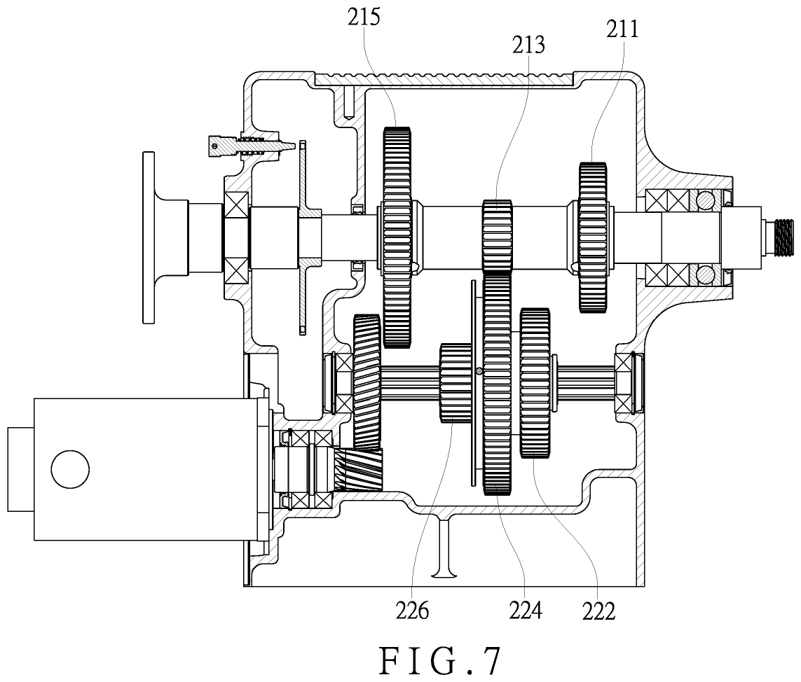

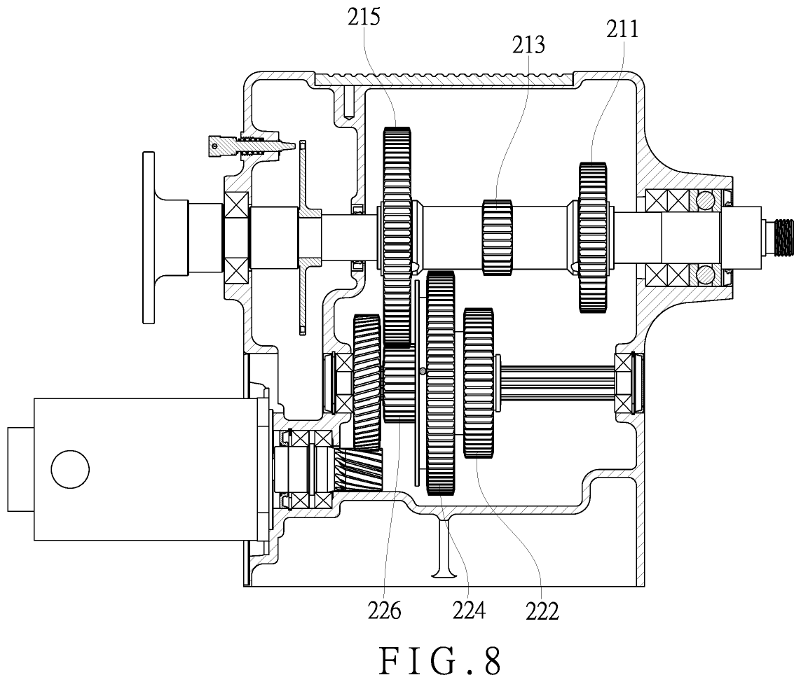

With reference to FIGS. 1-8, a transmission structure of a woodworking lathe according to a first embodiment of the present invention comprises:

a case 10 including a transmission shaft 11, a variable speed shaft 12, and a driven shaft 13, wherein the transmission shaft 11 is actuated by a motor, the driven shaft 13 is configured to drive a chuck of the woodworking lathe; a transmission gear 110 is mounted on the transmission shaft 11;

a driven gear 120 fixed on an end of the variable speed shaft 12 and meshing with the transmission gear 110; a first gear set 21 connected on the driven shaft 13 and comprised of a first gear 211, a third gear 213, and a fifth dear 215, wherein the first gear is coaxial with the third gear, diameters of the first gear 211, the third gear 213, and the fifth gear 215 are different; a second gear set 22 disposed on the variable speed shaft 12 and comprised of a second gear 222, a fourth gear 224, and a sixth gear 226, wherein a diameter of the second gear 222 corresponds to a diameter of the first gear 211, the fourth gear 224 is coaxial with the sixth gear 226, a diameter of the fourth gear 224 corresponds to a diameter of the third gear 213, and a diameter of the sixth gear 226 corresponds to a diameter of the fifth gear 215, wherein the second gear 222, the fourth gear 224, and the sixth gear 226 are connected on an end of the variable speed shaft 12 adjacent to the first gear set 21;

an adjustment lever 31 defined between the fourth gear 224 and the sixth gear 226 or between the second gear 222 and the fourth gear 224 so that the second gear set 22 moves leftward or rightward in fifth speed varying sections to control the second gear 222 to or not to mesh with the first gear 211 or to control the fourth gear 222 to or not to mesh with the third gear 213 or to control the sixth gear 226 to or not to mesh with the fifth gear 215.

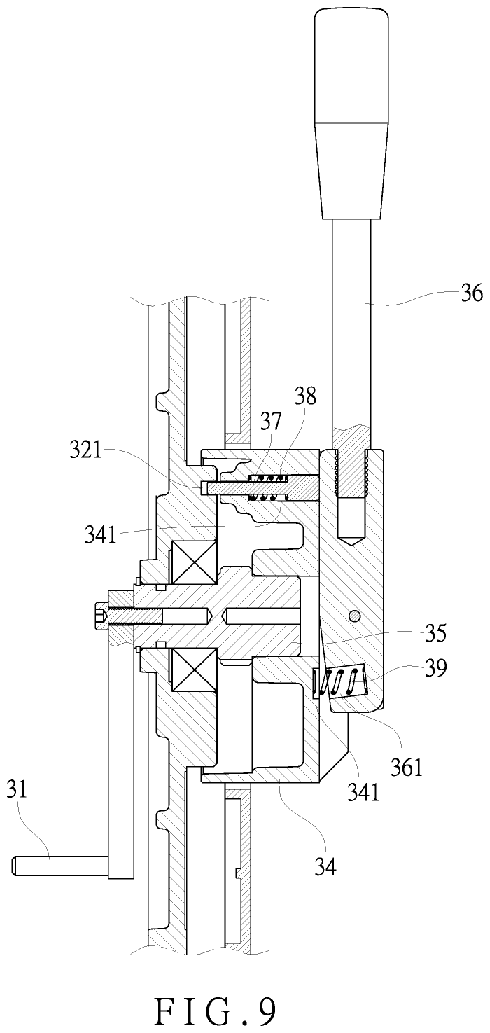

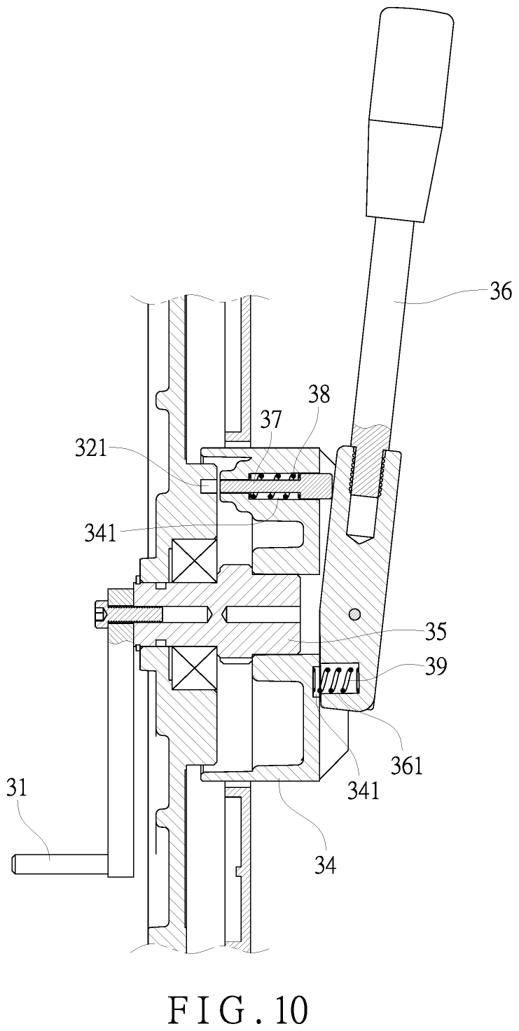

Referring to FIGS. 9-10, the transmission structure further comprises a speed change device is to control the adjustment lever 31, and the speed change device 30 includes: a positioning disc 32 locked on a fixing plate 33, and the fixing plate 33 is mounted on the case 10, wherein the positioning disc 32 has a through orifice 320 defined on a center thereof and five recesses 321 formed on the positioning disc 32; a rotatable disc 34 fixed outside the positioning disc 32 and having a first receiving groove 341 formed on the rotatable disc 34, wherein the first receiving groove 341 has a diameter formed on a recessed portion of a side thereof adjacent to the positioning disc 32, a second receiving groove 342 defined on a bottom of the rotatable disc 34; a defining post 35 having a first end locked on the rotatable disc 34, and a second end of the defining post 35 inserted through the through orifice 320 to lock with the adjustment lever 31; a handle 36 rotatably connected on an outer wall of the rotatable disc 34 and having a third receiving groove 361 defined on a bottom of the handle 36; a locating column 37 coupled on the handle 36 and inserted through a first spring 38 to be accommodated in the first receiving groove 341 and to engage with the five recesses 321, wherein the first spring 38 is configured to push the locating column 37 outward; a second spring 39 received in the second receiving groove 342 and the third receiving groove 361 and configured to push the handle 36 outward, wherein a pushing force of the second spring 39 to the locating column 37 is more than a pushing force of the first spring 38 to the locating column 37.

When changing meshing of different gears, the handle 36 is pulled outward so that the first spring 38 pushes the locating column 37 to remove from one of the five recesses 321, thus rotating the rotatable disc 34 leftward or rightward. When rotating the handle 36 to a next recess 321, the handle 36 is removed so that the second spring 39 urges the locating column 37 to move back to engage with the next recess 321.

For a ratio of diameters of the third, the first, the fifth, the sixth, the second, and the fourth gears, the diameter of the third gear 213 is less than the diameters of the first gear 211 and the fifth gear 215, and the diameter of the first gear 211 is less than the diameter of the fifth gear 215. The diameter of the sixth gear 226 is less than the diameters of the second gear 222 and the fourth gear 224, and the diameter of the second gear 222 is less than the diameter of the fourth gear 224.

Thereby, the transmission structure of the present invention has advantages as follows:

1) When the rotatable disc revolves, the second gear set 22 is actuated to rotate, thus changing the meshing of the different gears and a rotating speed and torque of the chuck to obtain using safety and convenience.

2) The adjustment lever 31 of the speed change device 30 is rotated in the fifth speed varying sections by using the five recesses 321 to control the second gear set 22 to move, thus adjusting different speeds and obtaining idle rotation and easy maintenance.

3) The gears are connected with the driven gear to enhance transmission efficiency and using life and to reduce abrasion and maintenance cost.

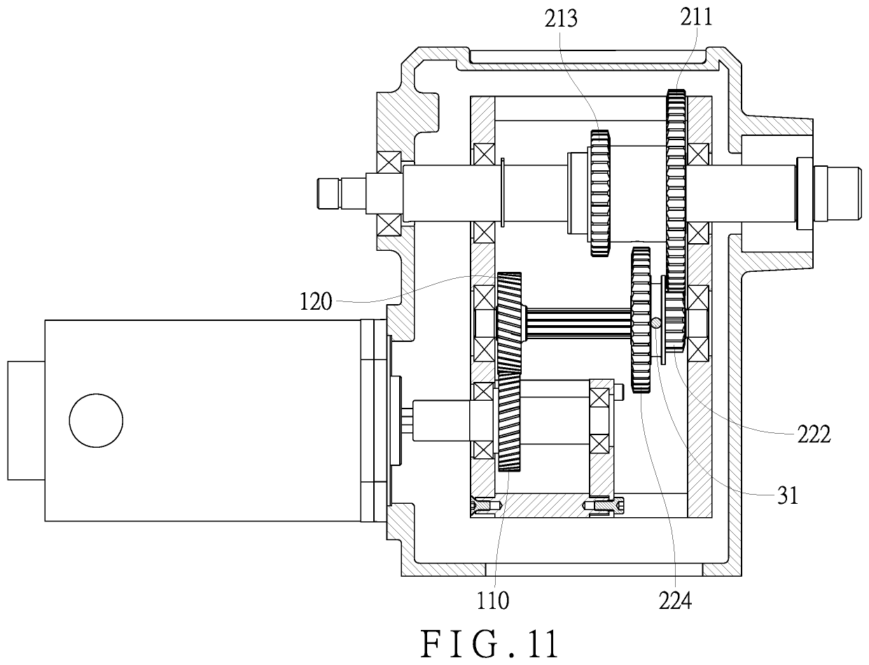

With reference to FIG. 11, in a second embodiment, the fifth gear 215 is eliminated from the first gear set 21, and the sixth gear 226 is eliminated from the second gear set 22. The adjustment lever 31 is defined between the second gear 222 and the fourth gear 224 so that the second gear set 22 moves leftward or rightward in three speed varying sections to control the second gear 222 to or not to mesh with the first gear 221 or to control the fourth gear 224 to or not to mesh with the third gear 213. Preferably, when the speed change device 30 mates with a direct current (DC) motor, the rotating speed of the DC motor is adjustable, thus obtaining more speed varying sections.

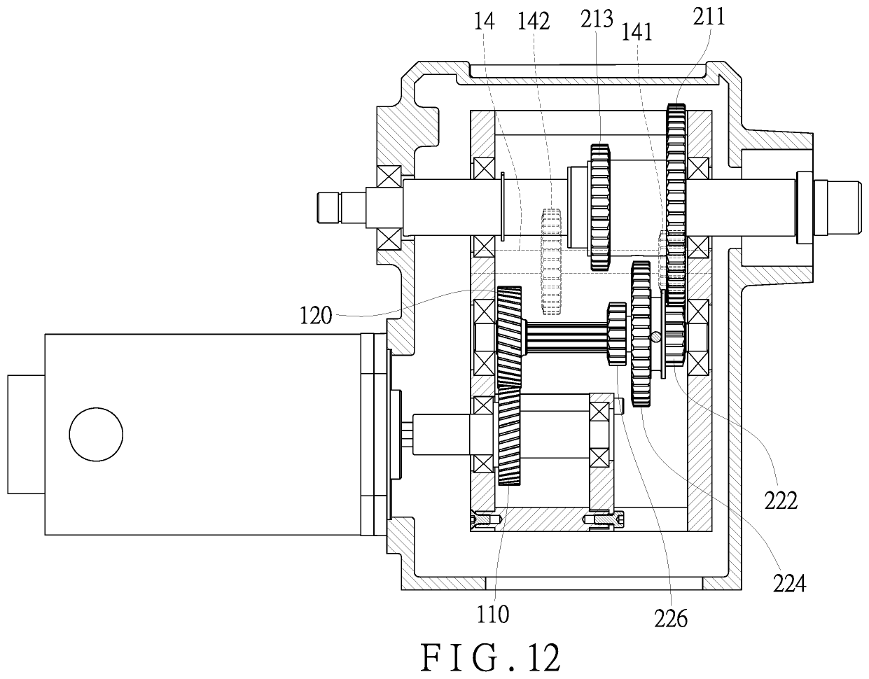

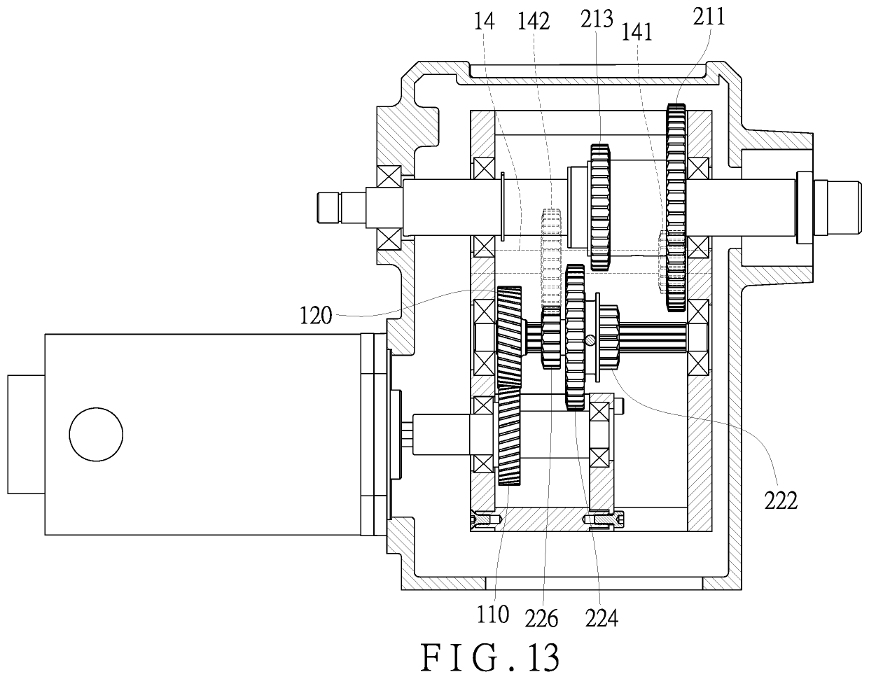

Referring to FIGS. 12 and 13, in a third embodiment, the fifth gear 215 is eliminated from the first gear set 21, and a second variable speed shaft 14 is located on a first variable speed shaft 12 and the driven shaft 13; a seventh gear 141 and an eighth gear 142 are arranged on two ends of the second variable speed shaft 14, wherein the eighth gear 142 meshes with the sixth gear 226, and the seventh gear 141 meshes with the first gear 211. The second gear set is controlled by the adjustment lever 31 to move in fourth speed varying sections so that the first gear 211 meshes with or does not mesh with the second gear 222 or the third gear 213 meshes with the fourth gear 224 or the eighth gear 142 meshes with the sixth gear 226.

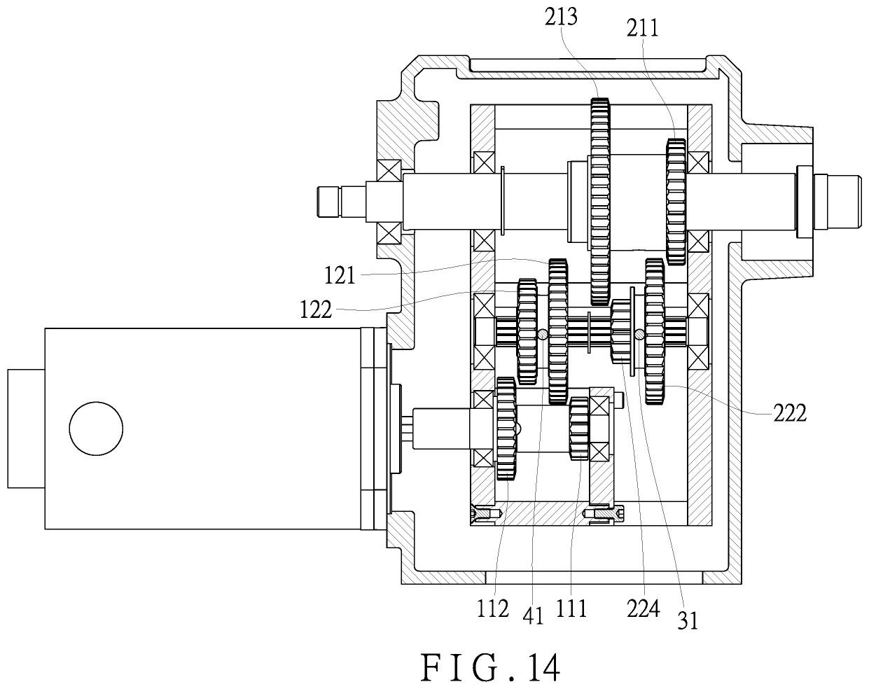

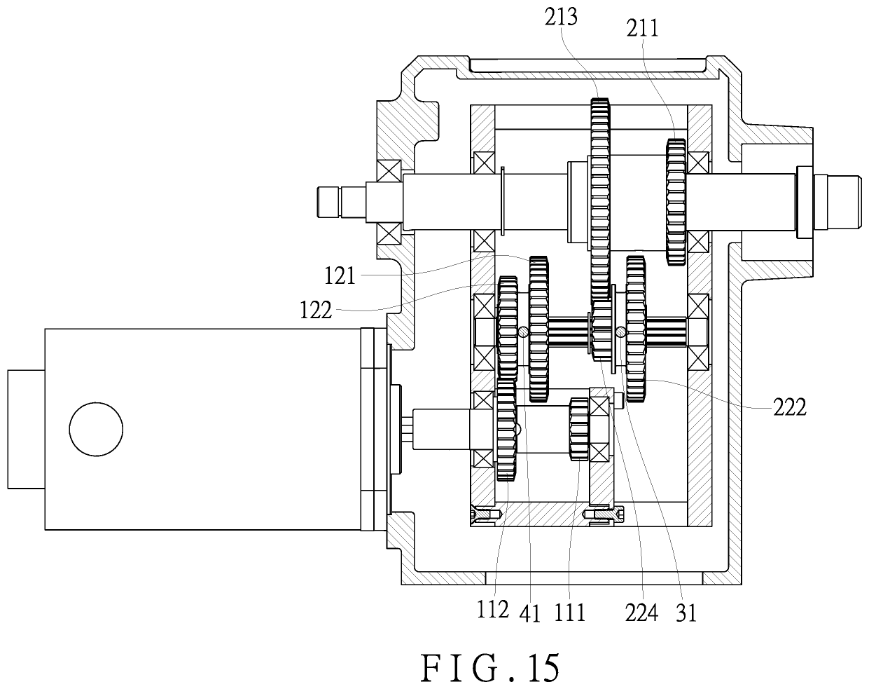

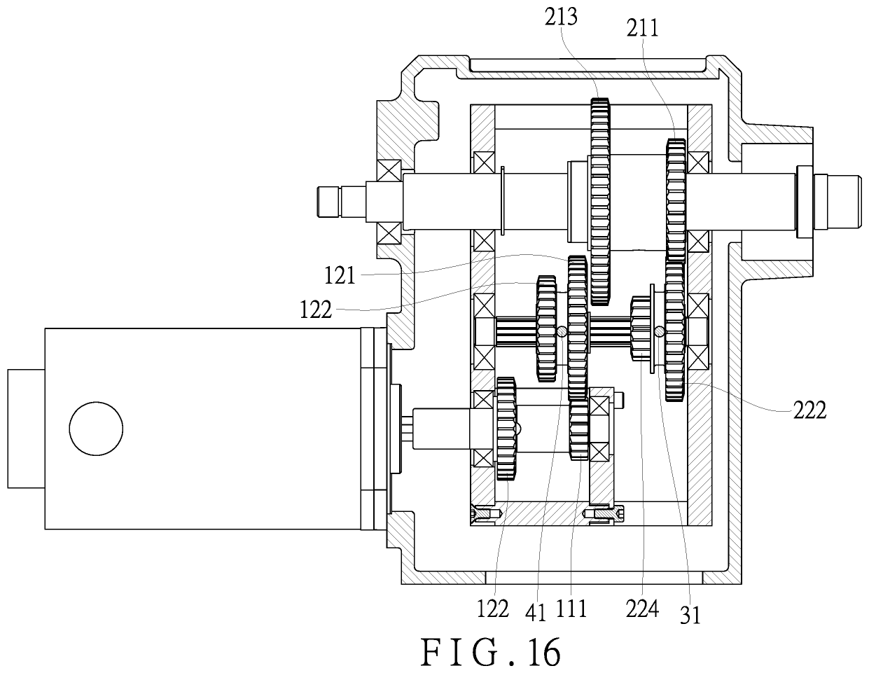

As shown in FIGS. 14-16, in a fourth embodiment, the transmission structure comprises: a third gear set, a fourth gear set, and a second adjustment lever 41. The third gear set includes a ninth gear 111 and an eleventh gear 112. The fourth gear set includes a tenth gear 121 and a twelfth gear 122. The second adjustment lever 41 is defined between the tenth gear 121 and the twelfth gear 122 and is configured to control the fourth gear set to move in third speed varying sections, such that the ninth gear 111 meshes with or does not mesh with the tenth gear 121 or the eleventh gear 112 meshes with the twelfth gear 122.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A transmission structure of a woodworking lathe comprising:
a case including a transmission shaft, a variable speed shaft, and a driven shaft, the transmission shaft being actuated by a motor, the driven shaft being configured to drive a chuck of the woodworking lathe;
a transmission gear mounted on the transmission shaft;
a driven gear fixed on an end of the variable speed shaft and meshing with the transmission gear;
a first gear set connected on the driven shaft and comprised of a first gear and a third gear which is coaxial with the first gear, and diameters of the first gear and the third gear being different;
a second gear set disposed on the variable speed shaft and comprised of a second gear and a fourth gear, a diameter of the second gear corresponding to a diameter of the first gear, a diameter of the fourth gear corresponding to a diameter of the third gear, and the second gear and the fourth gear being connected on an end of the variable speed shaft adjacent to the first gear set; and
an adjustment lever defined between the second gear and the fourth gear so that the second gear set moves leftward or rightward in three speed varying sections to control the second gear to or not to mesh with the first gear or to control the fourth gear to mesh with the third gear.

2. The transmission structure as claimed in claim 1, wherein a speed change device is configured to control the adjustment lever, and the speed change device includes:
a positioning disc locked on a fixing plate, and the fixing plate being mounted on the case, wherein the positioning disc has a through orifice defined on a center thereof and five recesses formed on the positioning disc;
a rotatable disc fixed outside the positioning disc and having a first receiving groove formed on the rotatable disc, wherein the first receiving groove has a diameter formed on a recessed portion of a side thereof adjacent to the positioning disc, a second receiving groove defined on a bottom of the rotatable disc;
a defining post having a first end locked on the rotatable disc, and a second end of the defining post inserted through the through orifice to lock with the adjustment lever; and
a handle rotatably connected on an outer wall of the rotatable disc and having a third receiving groove defined on a bottom of the handle;
a locating column coupled on the handle and inserted through a first spring to be accommodated in the first receiving groove and to engage with the five recesses, wherein the first spring is configured to push the locating column outward;
a second spring received in the second receiving groove and the third receiving groove and configured to push the handle outward, wherein a pushing force of the second spring to the locating column is more than a pushing force of the first spring to the locating column.

3. The transmission structure as claimed in claim 2, wherein
the first gear set is further comprised of a fifth gear located beside the third gear, and a diameter of the fifth gear is identical to the first gear and the third gear;
the second gear set is comprised of a sixth gear located beside the fourth gear, and a diameter of the sixth gear corresponds to the fifth gear; and
the second gear set is driven by the adjustment lever to move leftward or rightward in fifth speed varying sections to control the second gear to or not to mesh with the first gear or to control the fourth gear to or not to mesh with the third gear or to control the sixth gear to or not to mesh with the fifth gear.

4. The transmission structure as claimed in claim 3, wherein the diameter of the third gear is less than the diameters of the first gear and the fifth gear, and the diameter of the first gear is less than the diameter of the fifth gear; the diameter of the sixth gear is less than the diameters of the second gear and the fourth gear, and the diameter of the second gear is less than the diameter of the fourth gear.

5. The transmission structure as claimed in claim 4, wherein the adjustment lever is defined between the fourth gear and the sixth gear.

6. The transmission structure as claimed in claim 2, wherein the second gear set is comprised of:
a second variable speed shaft located on the first variable speed shaft and the driven shaft;
a seventh gear and an eighth gear arranged on two ends of the second variable speed shaft, wherein the eighth gear meshes with the sixth gear, and the seventh gear meshes with the first gear;
the second gear set is controlled by the adjustment lever to move in fourth speed varying sections so that the first gear meshes with or does not mesh with the second gear or the third gear meshes with the fourth gear or the eighth gear meshes with the sixth gear.

7. The transmission structure as claimed in claim 2, wherein a third gear set includes a ninth gear and an eleventh gear; a fourth gear set includes a tenth gear and a twelfth gear; a second adjustment lever is defined between the tenth gear and the twelfth gear and is configured to control the fourth gear set to move in third speed varying sections, such that the ninth gear meshes with or does not mesh with the tenth gear or the eleventh gear meshes with the twelfth gear.
